(19) United States
(12) Patent Application Publication
(10) Pub. No.: US 2021/0104716 A1
(43) Pub. Date: Apr. 8, 2021

(54) BATTERY INSTALLATION MECHANISM FOR ELECTRIC VEHICLE

(71) Applicant: Shanq-Ching SHIEH, CHANGHUA HSIEN (TW)

(72) Inventor: Shanq-Ching SHIEH, CHANGHUA HSIEN (TW)

(21) Appl. No.: 16/596,731

(22) Filed: Oct. 8, 2019

(51) Int. Cl. H01M 2/10

(52) U.S. Cl. CPC H01M 2/1083; H01M 2220/20

(57) ABSTRACT

A battery installation mechanism has a base, a battery, and a limiting assembly. The base has a supporting unit and a connecting mount. The supporting unit has two engaging holes. The connecting mount is connected to the base and has a connecting terminal. The battery is assembled to the base and has a cartridge for receiving battery cells, two engaging protrusions, a limiting protrusion protruding from the cartridge, and a battery terminal electrically connected to the connecting terminal. The limiting assembly has an assembling mount fastened to the base, a connecting member extending through the assembling mount, a limiting component and an operating handle respectively connected to two opposite ends of the connecting member, and an elastic unit abutting against the limiting component and the assembling mount. The limiting component is capable of blocking the limiting protrusion to limit the battery between the base and the limiting assembly.

### BACKGROUND OF THE INVENTION

### 1. Field of the Invention

The present invention relates to an electric vehicle, and more particularly to a battery installation mechanism of an electric vehicle that facilitates convenience in battery replacement.

### 2. Description of Related Art

With increasing power storage capacities of batteries, more and more vehicles are driven by electric motors that consume electrical power. The vehicles driven by electric motors, the so-called electric vehicles, may be electric bicycles, electric motorcycles, golf carts, or electric rollators.

To supply sufficient electric power for long distance traveling, batteries installed on the electric vehicles have to be replaced when running out of electric power. During travel, vibrations generated both from operation of the electric motor and riding on uneven terrains. In order to prevent the batteries from separating from the electric vehicles due to vibrations, conventional electric vehicles have battery installation mechanisms for holding batteries. However, the battery installation mechanisms of the conventional electric vehicles generally have disadvantage of difficulty in installation and replacement. To overcome the shortcomings of the battery installation mechanisms of the conventional electric vehicles, the present invention provides a battery installation mechanism for electric vehicles to mitigate or obviate the aforementioned problems.

### SUMMARY OF THE INVENTION

The main objective of the present invention is to provide a battery installation mechanism that facilitates ease in battery replacement. The battery installation mechanism has a base, a battery, and a limiting assembly. The base has a supporting unit and a connecting mount. The supporting unit has two engaging holes. The connecting mount is connected to the base and has a connecting terminal. The battery is assembled to the base and has a cartridge for receiving battery cells, two engaging protrusions, a limiting protrusion protruding from the cartridge, and a battery terminal electrically connected to the connecting terminal. The limiting assembly has an assembling mount fastened to the base, a connecting member extending through the assembling mount, a limiting component and an operating handle respectively connected to two opposite ends of the connecting member, and an elastic unit abutting against the limiting component and the assembling mount. The limiting component is capable of blocking the limiting protrusion to limit the battery between the base and the limiting assembly.

Therefore, the battery installation mechanism in accordance with the present invention is convenient in battery replacement.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a battery installation mechanism in accordance with the present invention, showing the battery installation mechanism assembled to a rollator;

FIG. 2A is an enlarged perspective view of the battery installation mechanism in FIG. 1;

FIG. 2B is a partially enlarged perspective view of a base of the battery installation mechanism in FIG. 2A;

FIG. 3A is an enlarged perspective view of a base and a limiting assembly of the battery installation mechanism in FIG. 2A;

FIG. 3B is a partially enlarged perspective view of the limiting assembly of the battery installation mechanism in FIG. 3A;

FIG. 4 is an exploded perspective view of the limiting assembly in FIG. 3B;

FIG. 5 is a side view in partial section of the limiting assembly in FIG. 3B;

FIG. 6 is a perspective view of a battery of the battery installation mechanism in FIG. 1;

FIG. 7 is an operational perspective view of the battery installation mechanism in FIG. 1;

FIG. 8A is an operational side view in partial section of the battery installation mechanism in FIG. 1;

FIG. 8B is an enlarged cross sectional operational side view of the battery installation mechanism in FIG. 8A;

FIG. 9A is another operational side view in partial section of the battery installation mechanism in FIG. 1; and

FIG. 9B is another operational side view in partial section of the battery installation mechanism in FIG. 9A.

### DETAILED DESCRIPTION OF PREFERRED EMBODIMENTS

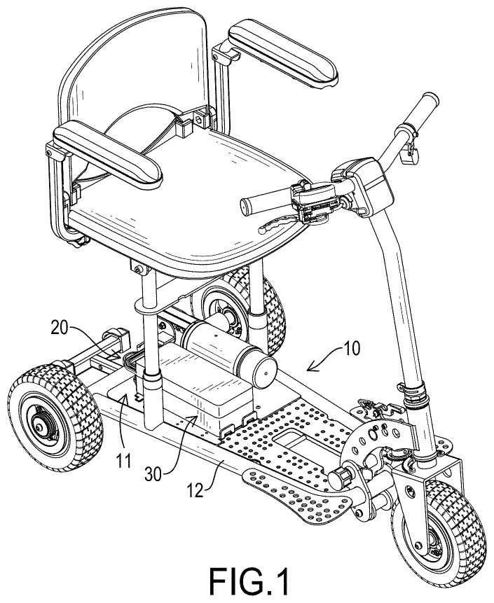

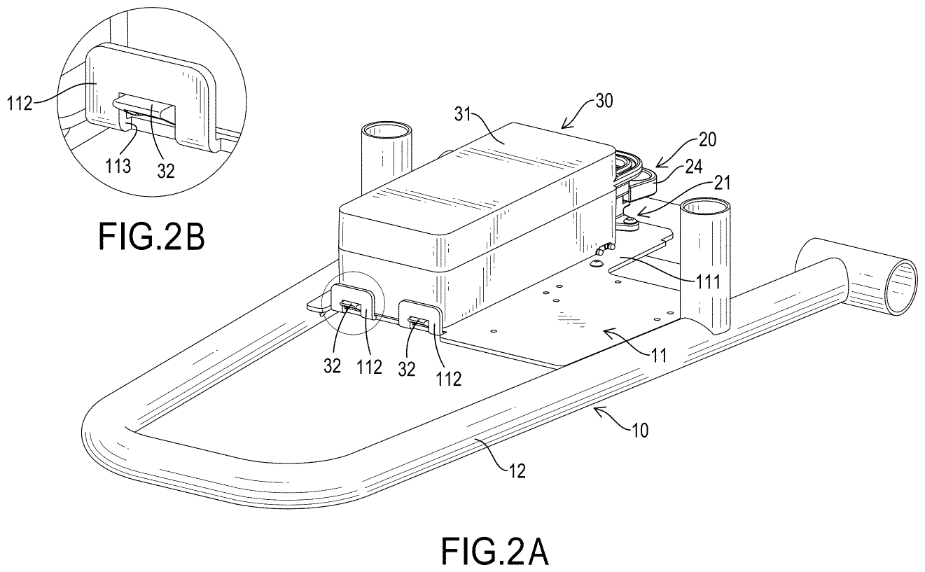

With reference to FIGS. 1 and 2, a battery installation mechanism assembled to a rollator has a base 10, a limiting assembly 20, and a battery 30. Wheels of the rollator are rotatably assembled to the base 10. The limiting assembly 20 and the battery 30 are assembled to the base 10. The battery 30 is limited between the base 10 and the limiting assembly 20.

With reference to FIGS. 1 to 3, the base 10 has a supporting unit 11, a frame 12, and a connecting mount 13. The supporting unit 11 has a supporting board 111, two engaging lugs 112, and two engaging holes 113. The two engaging lugs 112 are erectly connected to the supporting board 111. The two engaging holes 113 are respectively defined through the two engaging lugs 112. The frame 12 surrounds the supporting unit 11. The connecting mount 13 is connected to the supporting board 111 and has a connecting terminal 131.

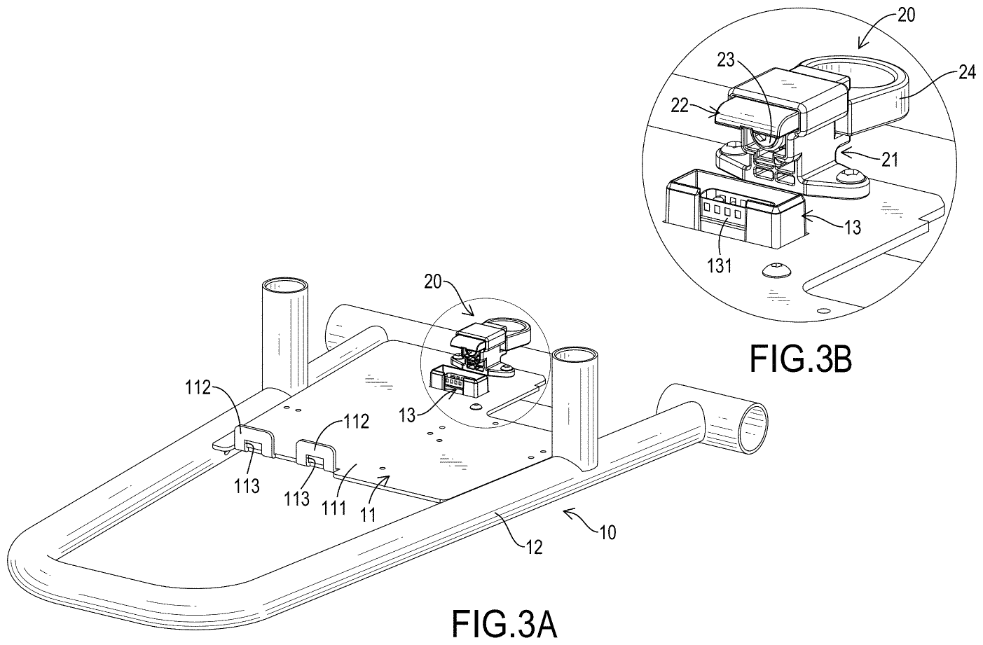

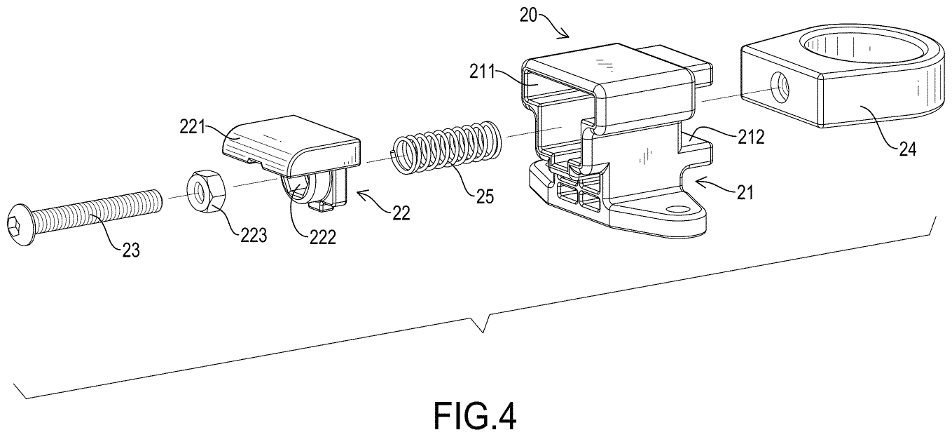

With reference to FIGS. 3 to 5, the limiting assembly 20 has an assembling mount 21, a limiting component 22, a connecting member 23, an operating handle 24, and an elastic unit 25. The assembling mount 21 is fastened to the supporting board 111. The assembling mount 21 has a receiving slot 211 and a containing groove 212. The receiving slot 211 has an opening and a bottom. The receiving slot 211 is defined in a face of the assembling mount 21, wherein the face faces to the two engaging lugs 112. The containing groove 212 is defined in another face of the assembling mount 21, wherein the face faces to a direction opposite to the two engaging lugs 112. The limiting component 22 is received in the receiving slot 211. The limiting component 22 has an abutted face 221 and an embedding recess 222. The abutted face 221 is exposed outside the receiving slot 211. The embedding recess 222 is defined in a portion of the limiting component 22, wherein the portion is disposed below the abutted face 221. A nut 223 is embedded in the embedding recess 222. In the present invention, the connecting member 23 is a bolt. The connecting member 23 extends through the assembling mount 21 and has two opposite ends. More specifically, the connecting member 23 is screwed with the nut 223, and one of the two opposite ends of the connecting member 23 is connected to the limiting component 22. The connecting member 23 extends through the limiting component 22, enters the receiving slot 211 of the assembling mount 21, extends through the bottom of the receiving slot 211, and enters the containing groove 212. The operating handle 24 is annular and is screwed with and connected to the other one of the two opposite ends of the connecting member 23. The elastic unit 25 has two opposite ends respectively abutting against the limiting component 22 and the bottom of the receiving slot 211 of the assembling mount 21. The elastic unit 25 is compressible and restorable between the limiting component 22 and the assembling mount 21. More specifically, the elastic unit 25 is a compression spring 25 mounted around the connecting member 23. As long as the elastic unit 25 is capable of being compressed and restoring between the limiting component 22 and the assembling mount 21, the elastic unit 25 can be any components with elasticity.

With reference to FIGS. 1, 2, and 6, in the present invention, the battery 30 is a lithium battery. The battery 30 is disposed between the two engaging lugs 112 and the assembling mount 21 and has a cartridge 31, two engaging protrusions 32, a limiting protrusion 33, a battery terminal 34, and a protecting lid 35. The cartridge 31 has a bottom, a first end, and a second end opposite the first end of the cartridge 31. The two engaging protrusions 32 protrude from the first end of the cartridge 31. The two engaging protrusions 32 are respectively inserted in the two engaging holes 113. The limiting protrusion 33 protrudes from the second end of the cartridge 31 and has an abutting portion 331. The abutting portion 331 inclines toward the bottom of the cartridge 31 and corresponds to the abutted face 221 of the limiting component 22 in shape. The abutting portion 331 is capable of abutting against the abutted face 221. When the limiting protrusion 33 is limited by the limiting component 22, the battery 30 is restricted between the base 10 and the limiting assembly 20. The battery terminal 34 is disposed at the bottom of the cartridge 31. The battery terminal 33 is capable of being electrically connected to the connecting terminal 131 of the connecting mount 13. The protecting lid 35 is pivotally connected to the cartridge 31 and is capable of covering the battery terminal 34.

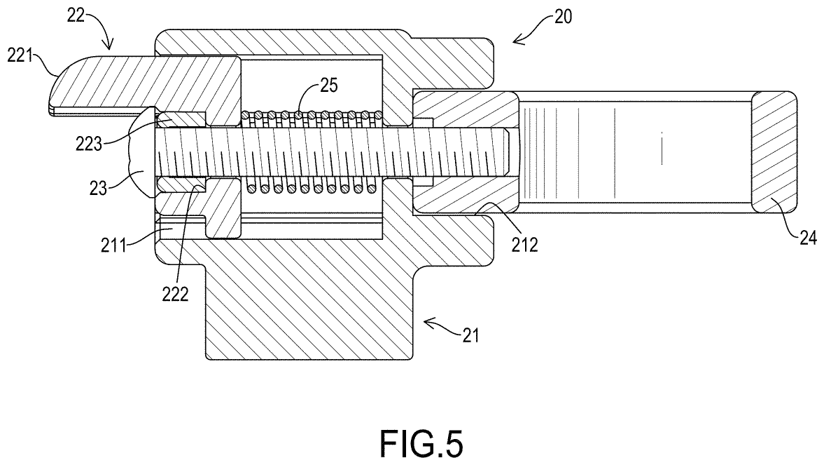

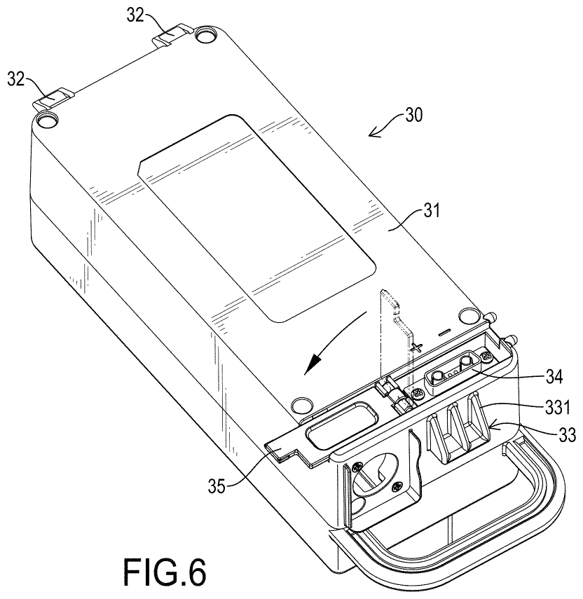

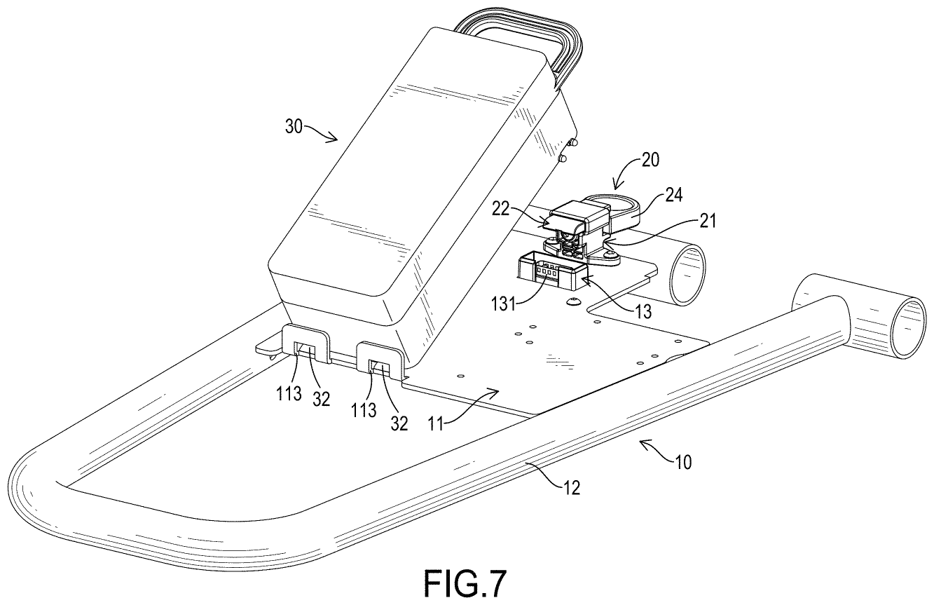

With reference to FIGS. 6 and 7, when the battery 30 is installed to the base 10, the protecting lid 35 is opened at first to expose the battery terminal 34. Then the two engaging protrusions 32 of the battery 30 are respectively inserted into the two engaging holes 113 of the supporting unit 11. With reference to FIGS. 5 to 7, when the second end of the cartridge 31 is swept toward the base 10, the abutting portion 331 of the limiting protrusion 33 abuts against the abutted face 221 of the limiting component 22. The limiting protrusion 33 pushes the limiting component 22 into the receiving slot 211 of the assembling mount 21. The limiting component 22 compresses the elastic unit 25 accordingly. With reference to FIGS. 6 to 8, when the battery terminal 34 is electrically connected to the connecting terminal 131 of the connecting mount 13, the abutting portion 331 no longer abuts against the abutted face 221. The elastic unit 25 restores and pushes the limiting component 22 out from the receiving slot 211 of the assembling mount 21. The limiting component 22 blocks above the limiting protrusion 33. Therefore, the battery 30 is limited between the base 10 and the limiting assembly 20.

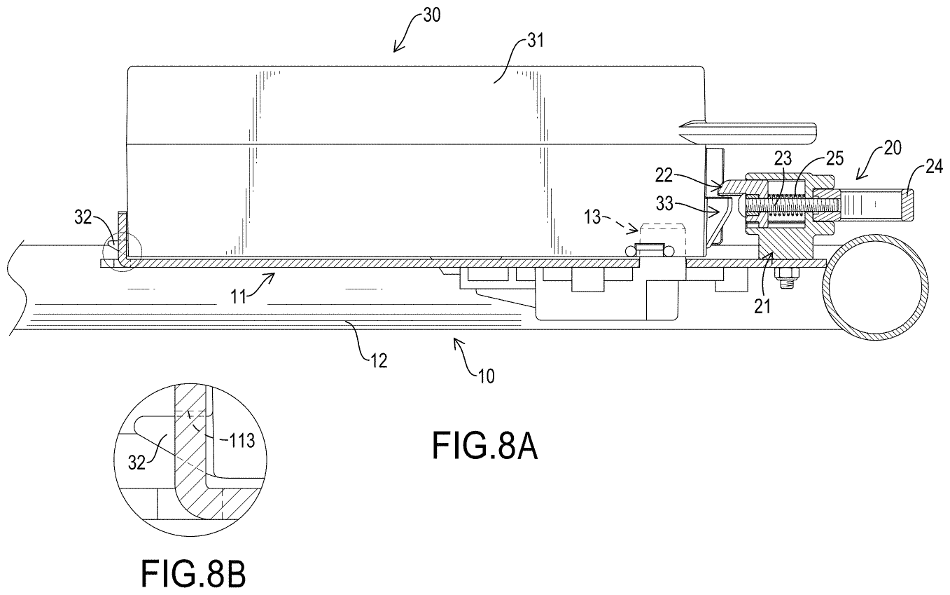

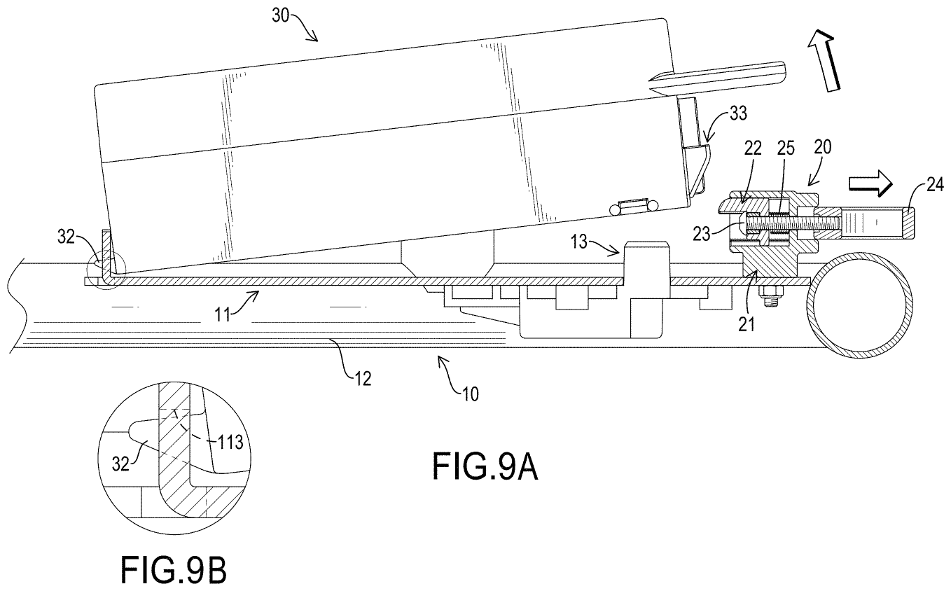

With reference to FIGS. 8 and 9, to remove the battery 30 from the base 10, the operating handle 24 of the limiting assembly 20 is pulled firstly. The operating handle 24 drags the limiting component 22 into the receiving slot 211 and does not block above the limiting protrusion 33 anymore. The second end of the cartridge 31 can be swept away from the base 10. The two engaging protrusions 32 of the battery 30 are retrieved from the two engaging holes 113. The battery 30 can be removed from the base 10 consequently. The battery installation mechanism in accordance with the present invention is simple in structure, is easy to operate, and is convenient for battery replacement, thereby having advantages in assembly and maintenance.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A battery installation mechanism comprising:
a base having
a supporting unit having
a supporting board;
two engaging lugs erectly connected to the supporting board; and
two engaging holes respectively defined through the two engaging lugs;
a connecting mount connected to the supporting board and having a connecting terminal;
a battery assembled to the base and having
a cartridge configured to receive battery cells and having a first end and a second end opposite to each other;
two engaging protrusions protruding from the first end of the cartridge;
a limiting protrusion protruding from the second end of the cartridge; and
a battery terminal disposed at a bottom of the cartridge and electrically connected to the connecting terminal; and
a limiting assembly having
an assembling mount fastened to the supporting board, wherein the battery is disposed between the two engaging lugs and the assembling mount;
a connecting member extending through the assembling mount and having two opposite ends;
a limiting component connected to one of the two opposite ends of the connecting member and blocking the limiting protrusion;
an operating handle connected to the other one of the two opposite ends of the connecting member; and
an elastic unit having two opposite ends respectively abutting against the limiting component and the assembling mount, the elastic unit being compressible and restorable between the limiting component and the assembling mount.

2. The battery installation mechanism as claimed in claim 1, wherein
the assembling mount has a receiving slot having an opening and a bottom;
the limiting component is received in the receiving slot; and
the two opposite ends of the elastic unit respectively abut against the limiting component and the bottom of the receiving slot.

3. The battery installation mechanism as claimed in claim 2, wherein the elastic unit is a compression spring mounted around the connecting member.

4. The battery installation mechanism as claimed in claim 3, wherein the battery has a protecting lid pivotally connected to the cartridge and capable of covering the battery terminal.

5. The battery installation mechanism as claimed in claim 4, wherein
the limiting protrusion has an abutting portion inclining toward the bottom of the cartridge; and
the limiting component has an abutted face being inclined, corresponding to the abutting portion in shape, and capable of being abutted by the abutting portion.

6. The battery installation mechanism as claimed in claim 1, wherein
the limiting component has an embedding recess;
the limiting assembly has a nut embedded in the embedding recess; and
the connecting member is a bolt screwed with the nut and the operating handle.

7. The battery installation mechanism as claimed in claim 2, wherein
the limiting component has an embedding recess;
the limiting assembly has a nut embedded in the embedding recess; and
the connecting member is a bolt screwed with the nut and the operating handle.

8. The battery installation mechanism as claimed in claim 3, wherein
the limiting component has an embedding recess;
the limiting assembly has a nut embedded in the embedding recess; and
the connecting member is a bolt screwed with the nut and the operating handle.

9. The battery installation mechanism as claimed in claim 4, wherein
the limiting component has an embedding recess;
the limiting assembly has a nut embedded in the embedding recess; and
the connecting member is a bolt screwed with the nut and the operating handle.

10. The battery installation mechanism as claimed in claim 5, wherein
the limiting component has an embedding recess;
the limiting assembly has a nut embedded in the embedding recess; and
the connecting member is a bolt screwed with the nut and the operating handle.

11. The battery installation mechanism as claimed in claim 6, wherein the assembling mount has a containing groove to selectively hold the operating handle inside.

12. The battery installation mechanism as claimed in claim 7, wherein the assembling mount has a containing groove to selectively hold the operating handle inside.

13. The battery installation mechanism as claimed in claim 8, wherein the assembling mount has a containing groove to selectively hold the operating handle inside.

14. The battery installation mechanism as claimed in claim 9, wherein the assembling mount has a containing groove to selectively hold the operating handle inside.

15. The battery installation mechanism as claimed in claim 10, wherein the assembling mount has a containing groove to selectively hold the operating handle inside.
